(19) United States
(12) Patent Application Publication
(10) Pub. No.: US 2018/0290507 A1
(43) Pub. Date: Oct. 11, 2018

(54) ONBOARD STORAGE DEVICE AND ONBOARD STORAGE SYSTEM

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventor: Akinori Usami, Yokkaichi, Mie (JP)

(21) Appl. No.: 15/766,024

(22) PCT Filed: Oct. 3, 2016
(86) PCT No.: PCT/JP2016/079332

§ 371 Date: Apr. 5, 2018

(30) Foreign Application Priority Data
Oct. 15, 2015 (JP) 2015-204040

(51) Int. Cl. B60C 23/04; G08C 17/02

(52) U.S. Cl. CPC B60C 23/0433; B60C 23/0486; B60C 23/0484; G08C 17/02

(57) ABSTRACT

Provided is an onboard storage device and an onboard storage system that can correctly store identification information of communication devices provided in the tires of the own vehicle even if tire rotation, tire replacement, or the like is performed. A monitoring device detects the existence or absence of a situation in which another vehicle is not present in the periphery of the vehicle. If the monitoring device detects the existence of a situation in which another vehicle is not present, the monitoring device transmits, to each of multiple detection devices that are respectively provided in the tires of the vehicle, a request signal that requests the sensor ID of the detection device. The monitoring device receives the sensor IDs that are transmitted by the detection devices in accordance with the request signals, and stores the received sensor IDs in a sensor ID table.

### CROSS-REFERENCE TO RELATED APPLICATIONS

This application is the U.S. national stage of PCT/JP2016/079332 filed Oct. 3, 2016, which claims priority of Japanese Patent Application No. JP 2015-204040 filed Oct. 15, 2015.

### TECHNICAL FIELD

The present disclosure relates to an onboard storage device and an onboard storage system.

This application claims priority based on Japanese Patent Application No. 2015-204040 filed on Oct. 15, 2015, and the entire contents of this Japanese patent application are hereby incorporated herein by reference.

### BACKGROUND

In order to obtain a uniform wear state for four tires mounted to a vehicle, tire rotation for interchanging the positions of the tires with each other is generally performed. JP 3636184B discloses a system in which even in the case where tire rotation is performed, the correspondence between the positions of the tires and identification information of detection devices for detecting the air pressure of the tires (air pressure sensor IDs) is automatically updated and stored in a memory. In the system disclosed in JP 3636184B, a request signal that requests identification information from the detection devices provided in the tires is transmitted from antennas that are provided in the vicinity of the tires. A monitoring device (reception device) receives identification information transmitted by the detection devices in accordance with the request signal, and if a received identification information piece is any one of four identification information pieces that are already registered in the memory, the monitoring device stores the received identification information piece in association with the corresponding tire position.

### SUMMARY

An onboard storage device according to this disclosure is an onboard storage device that receives and stores identification information pieces that are transmitted by a plurality of communication devices that are respectively provided in a plurality of tires of a vehicle and wirelessly transmit respective identification information pieces, the onboard storage device including: a reception unit that receives the identification information pieces respectively transmitted by the communication devices; a detection unit that detects existence or absence of a situation in which another vehicle is not present in a periphery of the vehicle; and a storage unit that, if the detection unit detected existence of a situation in which another vehicle is not present, stores the identification information pieces received by the reception unit.

An onboard storage system according to this disclosure includes the onboard storage device described above; and a plurality of communication devices that are respectively provided in a plurality of tires of a vehicle and wirelessly transmit respective identification information pieces.

### BRIEF DESCRIPTION OF THE DRAWINGS

FIG. 1 is a schematic diagram showing an example of a configuration of a tire air pressure monitoring system according to a first embodiment.

FIG. 2 is a block diagram showing an example of a configuration of a monitoring device.

FIG. 3 is a conceptual diagram showing an example of a sensor ID table.

FIG. 4 is a block diagram showing an example of a configuration of a detection device.

FIG. 5 is a flowchart showing a sensor ID update processing procedure according to the first embodiment.

FIG. 6 is a flowchart showing a sensor ID update processing procedure according to a first variation.

FIG. 7 is a flowchart showing a sensor ID update processing procedure according to a second variation.

FIG. 8 is a flowchart showing the sensor ID update processing procedure according to the second variation.

FIG. 9 is a flowchart showing a sensor ID update processing procedure according to a second embodiment.

FIG. 10 is a block diagram showing an example of a configuration of a monitoring device according to a third embodiment.

FIG. 11 is a flowchart showing a sensor ID update processing procedure according to the third embodiment.

### DETAILED DESCRIPTION OF THE PREFERRED EMBODIMENTS

Incidentally, when some tires are replaced with new tires along with detection devices, the monitoring device receives identification information that is different from the identification information that is already registered in the memory. In such a case, with the system disclosed in JP 3636184B, there is a problem that identification information cannot be updated.

In view of this, in the case where identification information received from detection devices is different from the identification information that is already registered in the memory, it is conceivable to register the received identification information in association with the corresponding tire positions. However, there is a possibility that a detection device provided in a tire of another vehicle in the vicinity will respond to a request signal transmitted by the monitoring device and transmit identification information to the monitoring device, and in this case, there is a risk that the identification information of the detection device of the other vehicle will be mistakenly registered.

The present disclosure was achieved in light of this situation, and an object thereof is to provide an onboard storage device and an onboard storage system that can correctly store the identification information of communication devices (detection devices) that are provided in the tires of an own vehicle.

### Effects of Disclosure

According to the present disclosure, it is possible to provide an onboard storage device and an onboard storage system that can correctly store the identification information of communication devices that are provided in the tires of an own vehicle.

### DESCRIPTION OF EMBODIMENTS OF INVENTION

First, aspects for carrying out the present disclosure will be described. Also, at least portions of the embodiments described below may be combined as desired.

(1) An onboard storage device according to an aspect of the present disclosure is an onboard storage device that receives and stores identification information pieces that are transmitted by a plurality of communication devices that are respectively provided in a plurality of tires of a vehicle and wirelessly transmit respective identification information pieces, the onboard storage device including: a reception unit that receives the identification information pieces respectively transmitted by the communication devices; a detection unit that detects existence or absence of a situation in which another vehicle is not present in a periphery of the vehicle; and a storage unit that, if the detection unit detected existence of a situation in which another vehicle is not present, stores the identification information pieces received by the reception unit.

In this aspect, the communication devices that wirelessly transmit the respective identification information pieces are respectively provided in the tires of the vehicle, and the onboard storage device receives and stores the identification information pieces transmitted by the communication devices. Upon detecting the existence of the situation in which another vehicle is not present in the periphery of the own vehicle, the onboard storage device receives and stores the identification information pieces transmitted by the communication devices. In other words, in the situation where another vehicle is not present in the periphery (vicinity) of the own vehicle, the onboard storage device acquires the identification information of the communication devices that are provided in the tires of the own vehicle. Accordingly, the identification information of a communication device of another vehicle in the vicinity is not mistakenly acquired (stored), and the identification information of the communication devices of the own vehicle can be correctly stored.

(2) A configuration is preferable in which the onboard storage device further includes a transmission unit that, if the detection unit detected existence of a situation in which another vehicle is not present, wirelessly transmits a request signal to each of the communication devices, the request signals requesting the identification information pieces, wherein the reception unit receives the identification information pieces that were transmitted by the communication devices in accordance with the request signals that were wirelessly transmitted by the transmission unit.

In this aspect, upon detecting the existence of the situation in which another vehicle is not present in the periphery of the own vehicle, the onboard storage device wirelessly transmits the identification information request signals to the communication devices. The onboard storage device then receives and stores the identification information that is transmitted by the communication devices in accordance with the transmitted request signals. Accordingly, the identification information of a communication device of another vehicle in the vicinity is not mistakenly acquired (stored), and the identification information of the communication devices of the own vehicle can be correctly stored. Also, identification information that was transmitted from the communication devices in accordance with the request signals transmitted by the onboard storage device is stored, and thus it is possible to store the identification information in association with the communication devices that were the request signal transmission destinations.

(3) A configuration is preferable in which if the detection unit detected that an air filling operation performed with respect to at least one tire started or ended, the detection unit determines existence of a situation in which another vehicle is not present in a periphery of the vehicle.

In this aspect, upon detecting that an air filling operation performed with respect to at least one tire has started or ended, the onboard storage device determines the existence of the situation in which another vehicle is not present in the periphery of the own vehicle. If a tire is being filled with air, there is a high possibility that another vehicle is not present in the periphery. Accordingly, by acquiring the identification information of the communication devices of the own vehicle in this case, it is possible to prevent the identification information of a communication device of another vehicle from being mistakenly acquired (stored).

(4) A configuration is preferable in which if the detection unit detected that an air pressure of at least one tire increased by a predetermined value or more, the detection unit determines existence of a situation in which another vehicle is not present in a periphery of the vehicle.

In this aspect, upon detecting that the air pressure of at least one tire has increased by a predetermined value or more, the onboard storage device determines the existence of the situation in which another vehicle is not present in the periphery of the own vehicle. If the air pressure of a tire has increased by the predetermined value or more, there is a high possibility that the tire is being filled with air, and there is a high possibility that another vehicle is not present in the periphery in this case. Accordingly, by acquiring the identification information of the communication devices of the own vehicle in this case, it is possible to prevent the identification information of a communication device of another vehicle from being mistakenly acquired (stored).

(5) A configuration is preferable in which if the detection unit detected that supply of fuel to the vehicle started or ended, the detection unit determines existence of a situation in which another vehicle is not present in a periphery of the vehicle.

In this aspect, upon detecting that the supply of fuel to the own vehicle has started or ended, the onboard storage device determines the existence of the situation in which another vehicle is not present in the periphery of the own vehicle. If fuel supply is performed, there is a high possibility that another vehicle is not present in the periphery. Accordingly, by acquiring the identification information of the communication devices of the own vehicle in this case, it is possible to prevent the identification information of a communication device of another vehicle from being mistakenly acquired (stored).

(6) A configuration is preferable in which if the reception unit received a larger number of identification information pieces than a total number of tires provided in the vehicle, the storage unit does not store the identification information pieces received by the reception unit.

In this aspect, if a larger number of identification information pieces than the number of tires provided in the vehicle is received, the onboard storage device does not store the received identification information. If a larger number of identification information pieces than the number of tires is received, not only has identification information been received from the communication devices of the own vehicle, but also identification information has been received from a communication device of another vehicle. Accordingly, by discarding the received identification information in this case, it is possible to prevent the identification information of a communication device of another vehicle from being mistakenly stored.

(7) A configuration is preferable in which the onboard storage device further includes: a temporary storage unit that, after the detection unit detected existence of a situation in which another vehicle is not present, if the reception unit received a total number of identification information pieces that is identical to a total number of tires provided in the vehicle, temporarily stores the identification information pieces received by the reception unit; and a determination unit that determines whether or not the vehicle started to travel, wherein the storage unit stores the identification information pieces received by the reception unit after the determination unit determines that the vehicle started to travel.

In this aspect, after detecting the existence of the situation in which another vehicle is not present in the periphery of the own vehicle, if the same number of identification information pieces as the number of tires is received, the onboard storage device temporarily stores the received identification information. If the same number of identification information pieces as the number of tires is received, there is a high possibility that the received identification information is the identification information of the communication devices of the own vehicle, and thus is temporarily stored. The onboard storage device then stores the received identification information after the vehicle has started to travel. Accordingly, even if mistaken identification information is temporarily stored, by re-registering identification information that was acquired after the vehicle started to travel, it is possible to register correct identification information.

(8) A configuration is preferable in which the reception unit receives the identification information pieces that were transmitted a plurality of times by each of the communication devices, the onboard storage device further includes a specification unit that specifies a corresponding identification information piece for each of the communication devices based on the plurality of identification information pieces received from each of the communication devices by the reception unit, and the storage unit stores the identification information pieces that were specified by the specification unit and correspond to the communication devices.

In this aspect, the onboard storage device specifies the identification information pieces that respectively correspond to the communication devices based on identification information that is transmitted multiple times by each of the communication devices, and stores the specified identification information. For example, the onboard storage device specifies the identification information piece that has the highest frequency of appearance based on the identification information pieces that are received from one communication device, and stores the specified identification information piece as the identification information of that communication device. The identification information having the highest frequency of appearance has a high possibility of being the identification information of the communication device of the own vehicle. Accordingly, this identification information is stored as the identification information of the communication device of the own vehicle, and therefore even if the identification information of a communication device of another vehicle is mistakenly received, it is possible to prevent the identification information of the communication device of the other vehicle from being stored.

(9) An onboard storage system according to an aspect of the present disclosure includes: any of the onboard storage devices described above; and a plurality of communication devices that are respectively provided in a plurality of tires of a vehicle and wirelessly transmit respective identification information pieces.

In this aspect, the onboard storage device does not mistakenly store the identification information of a communication device of another vehicle in the vicinity, and can correctly store the identification information of the communication devices of the own vehicle.

Note that the disclosure of the present application can not only be realized as an onboard storage device and an onboard storage system that include these characteristic processing units, but can also be realized as a storage method whose steps are these characteristic processes, or be realized as a program for causing a computer to execute these steps. Also, the disclosure can be realized as a semiconductor integrated circuit that realizes part of or the entirety of the onboard storage device or the onboard storage system, or be realized as another system that includes the onboard storage device or the onboard storage system.

### Detailed Description of Embodiments of Invention

There is a tire air pressure monitoring system (TPMS: Tire Pressure Monitoring System) that detects the air pressure of a tire mounted to a vehicle and issues a warning or the like to a user if the detected air pressure is abnormal. The tire air pressure monitoring system includes a detection device (communication device) that detects the air pressure of a tire and uses UHF band radio waves or the like to wirelessly transmit an air pressure signal pertaining to the detected air pressure, and a monitoring device that receives the air pressure signal that was wirelessly transmitted by the detection device, and monitors the tire air pressure based on the received air pressure signal. The detection device is provided in each of front-right, front-left, rear-right, and rear-left tires, and wirelessly transmits an air pressure signal that includes information regarding the detected air pressure and identification information for identifying the detection device. The monitoring device is provided on the vehicle body, and receives the air pressure signals transmitted by the detection devices. The monitoring device stores the positions of the tires of the vehicle (front-right, front-left, rear-right, and rear-left) and the identification information of the detection devices provided in the tires in association with each other in a memory. The monitoring device compares the identification information included in the air pressure signals received from the detection devices with the identification information stored in the memory. Accordingly, the monitoring device can determine which tire position corresponds to the air pressure information that is included in a received air pressure signal, and can be aware of the tire air pressure at each position.

Hereinafter, an onboard storage device and an onboard storage system according to aspects of the present disclosure will be described in detail based on embodiments applied to a tire air pressure monitoring system. Specific examples of a tire air pressure monitoring system according to embodiments of the present disclosure will be described below with reference to the drawings. Note that the present disclosure is not limited to these examples, but rather is indicated by the scope of the claims, and all changes that come within the meaning and range of equivalence of the claims are intended to be embraced therein.

### First Embodiment

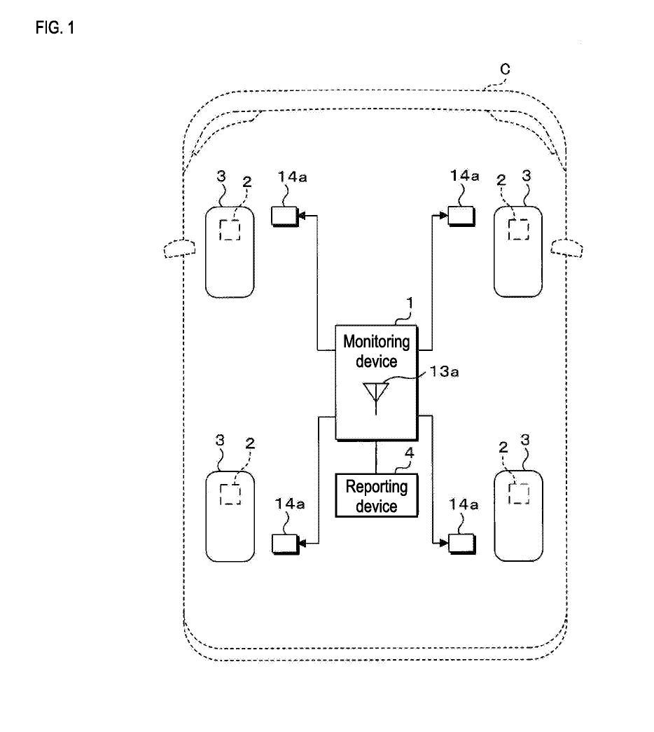

FIG. 1 is a schematic diagram showing an example of the configuration of a tire air pressure monitoring system according to a first embodiment of the present disclosure. The tire air pressure monitoring system of the first embodiment includes a monitoring device (onboard storage device) 1 provided at an appropriate location in a vehicle C, detection devices (communication devices) 2 that are respectively provided on the wheels of tires 3 mounted to the vehicle C, and a reporting device 4. In the tire air pressure monitoring system of the first embodiment, the monitoring device 1 acquires the air pressures of the tires 3 by performing wireless communication with the detection devices 2. The monitoring device 1 uses the reporting device 4 to issue an alert or a warning in accordance with the acquired air pressures. LF (Low Frequency) transmission antennas 14a that correspond to the tires 3 are connected to the monitoring device 1. For example, the LF transmission antennas 14a are provided in front-right, front-left, rear-right, and rear-left portions of the vehicle C. The monitoring device 1 uses LF band radio waves from the LF transmission antennas 14a to transmit to each of the detection devices 2 a request signal that requests air pressure information, a request signal that requests a sensor ID (identification information) for identifying the detection device 2, and the like. Upon receiving an air pressure request signal from the monitoring device 1, the detection devices 2 each detect the air pressure of the tire 3, and use UHF (Ultra High Frequency) band radio waves to transmit an air pressure signal pertaining to the detected air pressure to the monitoring device 1. Also, upon receiving a sensor ID request signal from the monitoring device 1, the detection devices 2 each use UHF band radio waves to transmit the sensor ID of the own device 2 to the monitoring device 1. Furthermore, the detection devices 2 each have a function of periodically detecting the air pressure of the tire 3 and voluntarily transmitting an air pressure signal to the monitoring device 1.

The monitoring device 1 also includes a UHF reception antenna 13a, uses the UHF reception antenna 13a to receive air pressure signals transmitted by the detection devices 2, and acquires information indicating the air pressures of the tires 3 from the air pressure signals. The monitoring device 1 also uses the UHF reception antenna 13a to receive sensor IDs transmitted by the detection devices 2. Note that the LF band and the UHF band are examples of the radio wave bands used when performing wireless communication, and the radio wave bands are not necessarily limited to these examples. The reporting device 4 is connected to the monitoring device 1 via a communication line. In the case of detecting that the air pressure of any of the tires 3 is below a predetermined threshold value based on the acquired information indicating the air pressures of the tires 3, the monitoring device 1 instructs the reporting device 4 to execute warning processing. Also, in the case of detecting that the air pressures of all of the tires 3 are in a predetermined range, the monitoring device 1 instructs the reporting device 4 to execute report processing for reporting that the air pressures of all of the tires 3 are normal. The reporting device 4 performs warning processing or report processing in accordance with an instruction from the monitoring device 1.

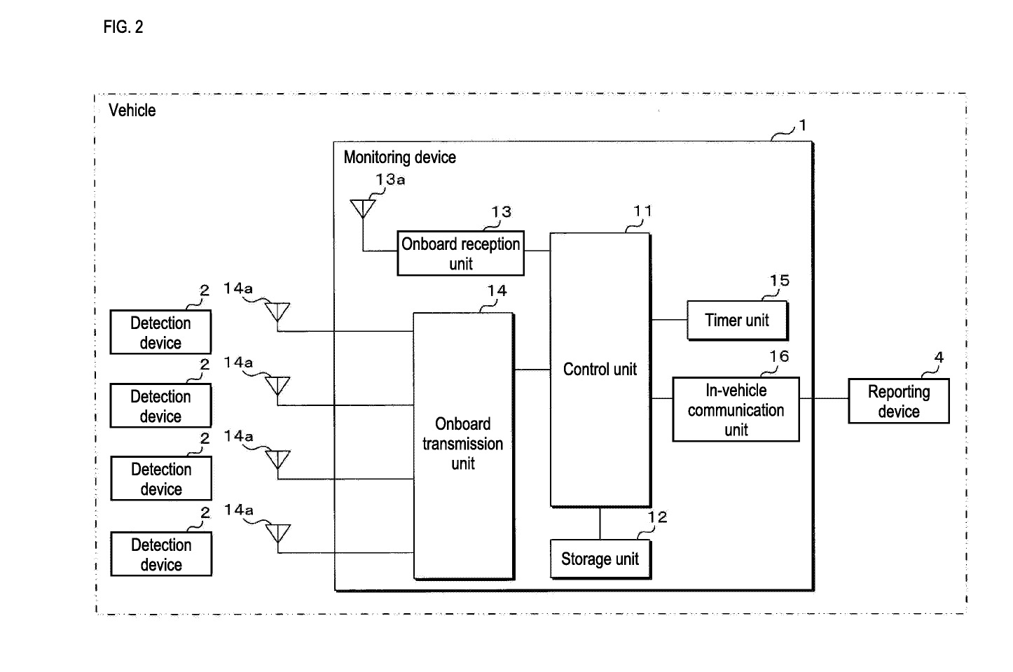

FIG. 2 is a block diagram showing an example of the configuration of the monitoring device 1. The monitoring device 1 includes a control unit 11 that controls operations of constituent units of the monitoring device 1. The control unit 11 is connected to a storage unit 12, an onboard reception unit 13, an onboard transmission unit 14, a timer unit 15, and an in-vehicle communication unit 16.

The control unit 11 is a microcontroller that has one or more CPUs (Central Processing Units) or a multi-core CPU, a ROM (Read Only Memory), a RAM (Random Access Memory), an input/output interface, and the like. The CPU of the control unit 11 is connected to the storage unit 12, the onboard reception unit 13, the onboard transmission unit 14, the timer unit 15, and the in-vehicle communication unit 16 via the input/output interface. By executing a control program stored in the storage unit 12, the control unit 11 controls the operations of the constituent units and executes communication processing and tire air pressure monitoring processing according to the present embodiment.

The storage unit 12 is a non-volatile memory such as an EEPROM (Electrically Erasable Programmable ROM) or a flash memory. The storage unit 12 stores a control program for the execution of communication processing and tire air pressure monitoring processing by the control unit 11 controlling the operations of the constituent units of the monitoring device 1. The storage unit 12 also stores a sensor ID table that stores the relationship between the four tire positions and the sensor IDs of the detection devices 2 of the tires 3 mounted at the tire positions.

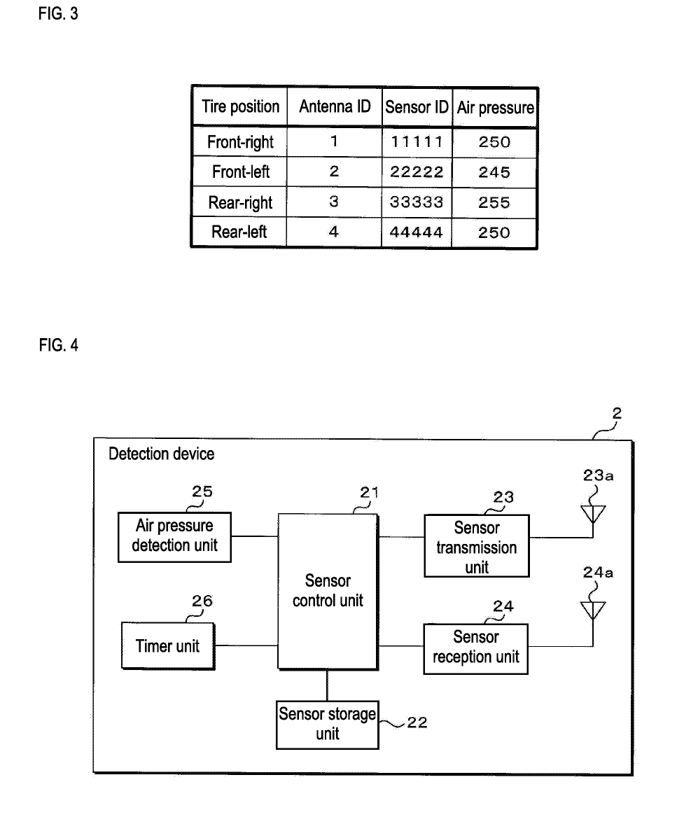

FIG. 3 is a conceptual diagram showing an example of the sensor ID table. The sensor ID table stores tire positions, antenna IDs for identifying the LF transmission antennas 14a, sensor IDs of the detection devices 2 provided on the tires 3 at the tire positions, and current air pressures of the tires 3 detected by the detection devices 2, in association with each other. The air pressures are numerical values in units of kPa, for example.

The UHF reception antenna 13a is connected to the onboard reception unit 13. The onboard reception unit 13 uses the UHF reception antenna 13a to receive signals that were transmitted by the detection devices 2 using UHF band radio waves. The onboard reception unit 13 is a circuit that demodulates the received signals and outputs the demodulated signals to the control unit 11. The 300 MHz to 3 GHz UHF band is used as the carrier wave, but the present disclosure is not limited to this frequency band.

The onboard transmission unit 14 is a circuit that modulates signals output by the control unit 11 into LF band signals, and transmits the modulated signals from the LF transmission antennas 14a to the respective detection devices 2. The 30 kHz to 300 kHz LF band is used as the carrier wave, but the present disclosure is not limited to this frequency band.

The timer unit 15 is constituted by a timer, a real-time clock, or the like, and starts timing under control of the control unit 11 and gives a timing result to the control unit 11.

The in-vehicle communication unit 16 is a communication circuit that performs communication in accordance with a communication protocol such as CAN (Controller Area Network) or LIN (Local Interconnect Network), and is connected to the reporting device 4. The in-vehicle communication unit 16 transmits a signal that instructs the execution of warning processing or report processing to the reporting device 4 under control of the control unit 11.

The reporting device 4 is a lamp, a buzzer, a speaker, or a display unit that is provided in the vehicle C, for example. The reporting device 4 issues a warning or a report to a driver or the like by lighting or blinking a lamp, sounding a buzzer, outputting audio from a speaker, displaying a message on a display unit, or the like in accordance with a signal received from the in-vehicle communication unit 16.

FIG. 4 is a block diagram showing an example of the configuration of a detection device 2. The detection device 2 includes a sensor control unit 21 that controls the operations of constituent units of the detection device 2. The sensor control unit 21 is connected to a sensor storage unit 22, a sensor transmission unit 23, a sensor reception unit 24, an air pressure detection unit 25, and a timer unit 26.

The sensor control unit 21 is a microcontroller that has one or more CPUs or a multi-core CPU, a ROM, a RAM, an input/output interface, and the like. The CPU of the sensor control unit 21 is connected to the sensor storage unit 22, the sensor transmission unit 23, the sensor reception unit 24, the air pressure detection unit 25, and the timer unit 26 via the input/output interface. The sensor control unit 21 reads out a control program stored in the sensor storage unit 22, and controls various units. The detection device 2 includes a battery (not shown), and operates using power from this battery.

The sensor storage unit 22 is a non-volatile memory. The sensor storage unit 22 stores a control program for the CPU of the sensor control unit 21 to perform processing related to the detection and transmission of the air pressure of a tire 3. Also a sensor ID that is unique to the detection device 2 is stored in advance in the sensor storage unit 22.

The air pressure detection unit 25 includes a diaphragm, for example, and detects the air pressure of the tire 3 based on a diaphragm deformation amount that varies according to the magnitude of pressure. The air pressure detection unit 25 outputs a signal indicating the detected air pressure of the tire 3 to the sensor control unit 21. By executing a control program, the sensor control unit 21 acquires the air pressure of the tire 3 from the air pressure detection unit 25, generates an air pressure signal that includes information indicating the air pressure, the sensor ID of the detection device 2, and the like, and outputs the air pressure signal to the sensor transmission unit 23.

The sensor control unit 21 also has a function of detecting that the filling of the tire 3 with air has started, that the filling of the tire 3 with air is complete, and the like based on the air pressure of the tire 3 that is acquired from the air pressure detection unit 25. Specifically, if the air pressure of the tire 3 has increased, the sensor control unit 21 determines that the filling of the tire 3 with air has started. Also, after the filling of the tire 3 with air has started, when the air pressure of the tire 3 is greater than or equal to a predetermined threshold value, the sensor control unit 21 determines that the filling of the tire 3 with air is complete. Upon detecting the start or the completion of the filling of the tire 3 with air, the sensor control unit 21 generates a filling operation signal (filling start signal or filling complete signal) that includes information indicating the start or the completion of filling and information indicating the sensor ID or the like, and outputs the filling operation signal to the sensor transmission unit 23.

A UHF transmission antenna 23a is connected to the sensor transmission unit 23. The sensor transmission unit 23 demodulates the air pressure signal and the filling operation signal that were generated by the sensor control unit 21 to obtain UHF band signals, and transmits the demodulated air pressure signal and filling operation signal with use of the UHF transmission antenna 23a.

An LF reception antenna 24a is connected to the sensor reception unit 24. The sensor reception unit 24 uses the LF reception antenna 24a to receive a request signal that was transmitted from the monitoring device 1 using LF band radio waves, and outputs the received signal to the sensor control unit 21.

The timer unit 26 is constituted by a timer, a real-time clock, or the like, and starts timing under control of the sensor control unit 21 and gives a timing result to the sensor control unit 21.

In the tire air pressure monitoring system having the above-described configuration, in each of the detection devices 2, the air pressure of the tire 3 is periodically detected by the air pressure detection unit 25, and an air pressure signal that includes the detected air pressure of the tire 3, the sensor ID of the own device 2, and the like is voluntarily transmitted from the sensor transmission unit 23 to the monitoring device 1. Upon receiving an air pressure signal that was transmitted from one of the detection devices 2, the monitoring device 1 extracts the air pressure of the tire 3 and the sensor ID from the received air pressure signal. The air pressure field that corresponds to the extracted sensor ID in the sensor ID table stored in the storage unit 12 is updated to the extracted air pressure by the monitoring device 1. According to this processing, the monitoring device 1 can monitor the air pressures of the tires 3 in real-time. Note that if any of the successively updated air pressures of the tires 3 is not normal or is below a predetermined threshold value for example, the monitoring device 1 issues a warning with use of the reporting device 4.

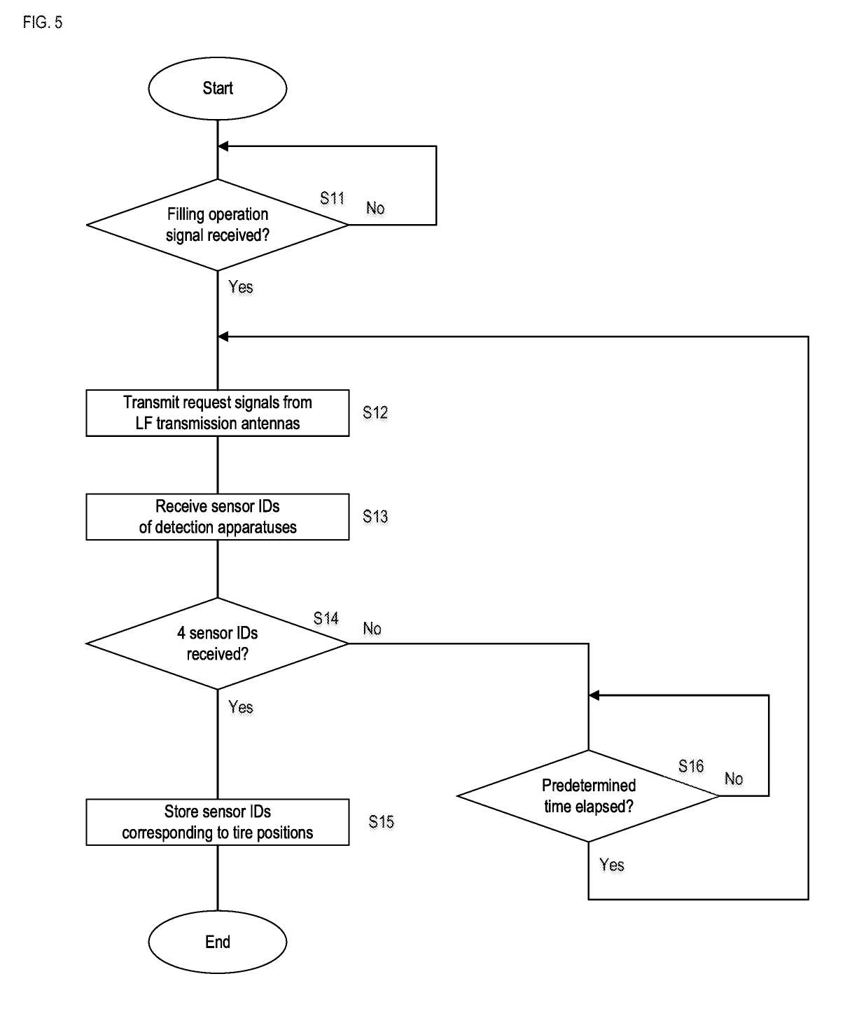

Next, processing for updating a sensor ID registered in the sensor ID table will be described. FIG. 5 is a flowchart showing a sensor ID update processing procedure according to the first embodiment. Note that the LF transmission antennas 14a are fixed to the vehicle C, and therefore the correspondence relationship between the tire positions and the antenna IDs of the LF transmission antennas 14a in the sensor ID table does not change after the LF transmission antennas 14a are attached to the vehicle C. In contrast, the detection devices 2 are replaced along with the tires 3, and therefore the correspondence relationship between the tire positions and the sensor IDs of the detection devices 2 changes each time a tire 3 is replaced. Accordingly, by performing the following processing, even if a tire 3 is replaced, the monitoring device 1 can appropriately update the correspondence relationship between the tire positions and the sensor IDs of the detection devices 2 in the sensor ID table.

The control unit 11 of the monitoring device 1 determines whether or not a filling operation signal transmitted by any of the detection devices 2 was received by the onboard reception unit 13 (S11), and upon determining that a filling operation signal has not been received (S11: NO), waits until a filling operation signal is received.

Upon determining that a filling operation signal was received (S11: YES), the control unit 11 transmits, with use of the onboard transmission unit (transmission unit) 14, respective request signals for requesting the sensor IDs of the detection devices 2 from the LF transmission antennas 14a (S12). Note that here, it is sufficient that the monitoring device 1 can acquire the sensor IDs of the detection devices 2, and therefore besides the sensor ID request signals, air pressure signal request signals may be transmitted from the LF transmission antennas 14a.

With use of the onboard reception unit (reception unit) 13, the control unit 11 receives sensor IDs that are transmitted from the detection devices 2 in accordance with the request signals that were transmitted in step S12 (S13). Note that the control unit 11 stores the received sensor IDs in association with the tire positions. For example, in the case of transmitting a request signal from the LF transmission antenna 14a that is provided in the front-right portion of the vehicle C, the sensor ID that was received from a detection device 2 in accordance with the request signal is stored by the control unit 11 as the sensor ID that corresponds to the front-right tire position. The sensor IDs are stored in a similar manner for the other tire positions as well.

After the processing of steps S12 and S13, the control unit 11 determines whether or not four sensor IDs were received (S14). Upon determining that four sensor IDs were received (S14: YES), the sensor IDs that correspond to the tire positions and were received in step S13 are stored as (used to update) the sensor IDs that correspond to the tire positions in the sensor ID table by the control unit 11 (S15), and then the control unit 11 ends this processing.

Upon determining that four sensor IDs were not received (S14: NO), for example if only three or fewer sensor IDs were received, or if five or more sensor IDs were received, the control unit 11 waits for a predetermined time. Specifically, the control unit 11 determines whether or not a predetermined time has elapsed through timer processing performed by the timer unit 15 (S16), and upon determining that the predetermined time has not elapsed (S16: NO), the control unit 11 waits. Upon determining that the predetermined time has elapsed (S16: YES), the control unit 11 returns to the processing of step S12, and performs the processing of steps S12 to S14 once again.

The case where four sensor IDs were not received is conceivably the case where a sensor ID was not received from a detection device 2 of the own vehicle C, or the case where a sensor ID was received from a detection device of another nearby vehicle. In such a case, the control unit 11 discards the received sensor IDs instead of storing them, and then performs the processing of steps S12 to S14 once again. Accordingly, the sensor IDs of the detection devices 2 of the own vehicle C are reliably acquired, thus preventing the sensor ID of a detection device of another vehicle from being mistakenly registered in the sensor ID table.

By performing the above-described processing each time a filling operation signal is received from any of the detection devices 2, the control unit 11 successively updates the correspondence relationship between the tire positions and the sensor IDs in the sensor ID table. Accordingly, the correspondence relationship between the tire positions and the sensor IDs in the sensor ID table is appropriately updated without attention from the driver, a mechanic, or the like.

When the tires 3 are filled with air, the possibility that another vehicle is present nearby the vehicle C is low. Accordingly, if the monitoring device 1 acquires the sensor IDs of the detection devices 2 of the own vehicle C in such a situation, it is possible to suppress the case where the sensor ID of a detection device of another vehicle is mistakenly acquired. The control unit 11 of the first embodiment has a function of a detection unit that, by determining whether or not a filling operation signal was received from a detection device 2, detects the existence or absence of a situation in which another vehicle is not present in the periphery of the own vehicle C, that is to say the existence or absence of a situation in which the sensor IDs acquired from the detection devices 2 may be stored (registered) in the sensor ID table. Note that it is sufficient that the control unit 11 can detect that a tire 3 of the own vehicle C is being filled with air, and therefore the filling operation signal received from a detection device 2 may be the filling start signal or the filling end signal.

First Variation

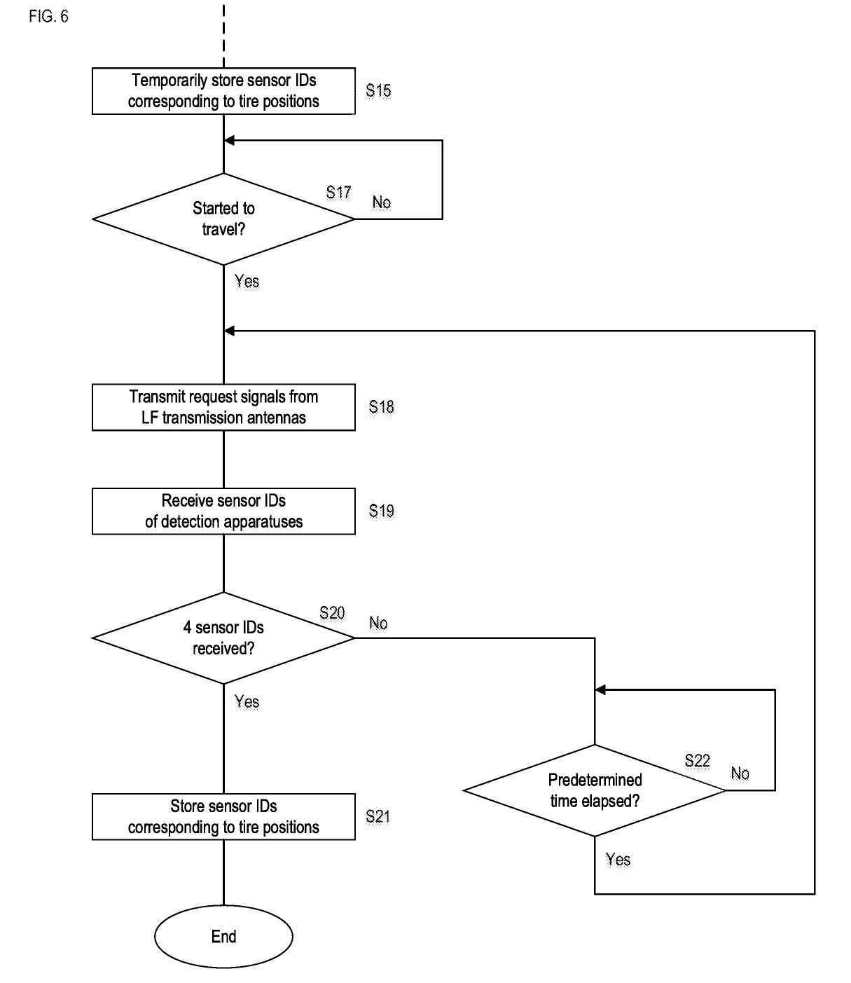

The following describes a variation of processing for updating sensor IDs registered in the sensor ID table. FIG. 6 is a flowchart showing a sensor ID update processing procedure according to the first variation. In the processing procedure according to the first variation, the control unit 11 of the monitoring device 1 executes processing similar to processing (steps S11 to S16) in the processing procedure shown in FIG. 5. Note that in step S15, the sensor IDs that correspond to the tire positions and were received in step S13 are temporarily stored by the control unit 11 as the sensor IDs that correspond to the tire positions in the sensor ID table. At this time, the storage unit 12 that stores the sensor ID table functions as a temporary storage unit.

After the processing of step S15, the control unit (determination unit) 11 determines whether or not the vehicle C has started to travel (S17). An ignition switch or a vehicle speed sensor that detects the traveling speed of the vehicle C, for example, is connected to the monitoring device 1. The control unit 11 of the monitoring device 1 determines whether or not the vehicle C has started to travel based on the vehicle speed input from the vehicle speed sensor or the on/off state of the ignition switch.

Upon determining that the vehicle C has not started to travel (S17: NO), the control unit 11 waits until the vehicle C starts to travel.

Upon determining that the vehicle C has started to travel (S17: YES), the control unit 11 performs the processing of steps S12 to S14 once again. Specifically, the control unit 11 transmits a request signal for requesting the sensor IDs of the detection devices 2 with use of the onboard transmission unit 14 (S18), and receives the sensor IDs transmitted by the detection devices 2 in response to the transmitted request signal with use of the onboard reception unit 13 (S19). Note that here as well, the control unit 11 stores the received sensor IDs in association with the tire positions. The control unit 11 determines whether or not four sensor IDs were received (S20). Upon determining that four sensor IDs were received (S20: YES), the sensor IDs that correspond to the tire positions and were received in step S19 are stored as (used to update) the sensor IDs that correspond to the tire positions in the sensor ID table by the control unit 11 (S21), and then the control unit 11 ends this processing.

Upon determining that four sensor ID were not received (S20: NO), the control unit 11 waits for a predetermined time. Specifically, the control unit 11 determines whether or not a predetermined time has elapsed through timer processing performed by the timer unit 15 (S22), and upon determining that the predetermined time has not elapsed (S22: NO), the control unit 11 waits. Upon determining that the predetermined time has elapsed (S22: YES), the control unit 11 returns to the processing of step S18, and performs the processing of steps S18 to S20 once again.

According to the above-described processing, the control unit 11 can acquire sensor IDs from the detection devices 2 and temporarily store them in the sensor ID table when the tires 3 are filled with air. Accordingly, the sensor IDs of the detection devices 2 of the own vehicle C can be registered in the sensor ID table even before the own vehicle C starts to travel. The control unit 11 can also acquire sensor IDs from the detection devices 2 and store them in the sensor ID table after the vehicle C starts to travel. Accordingly, even if an erroneous sensor ID is acquired when the tires 3 are filled with air, the sensor IDs of the detection devices 2 of the own vehicle C are acquired after the vehicle C starts to travel, thus making it possible to prevent the sensor ID of the detection device of the other vehicle from being mistakenly registered in the sensor ID table.

Second Variation

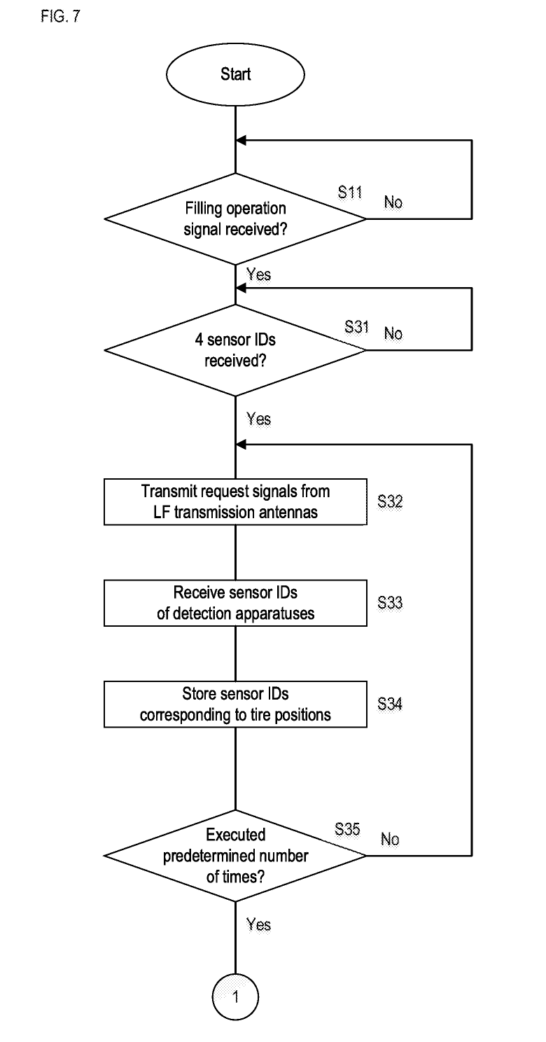

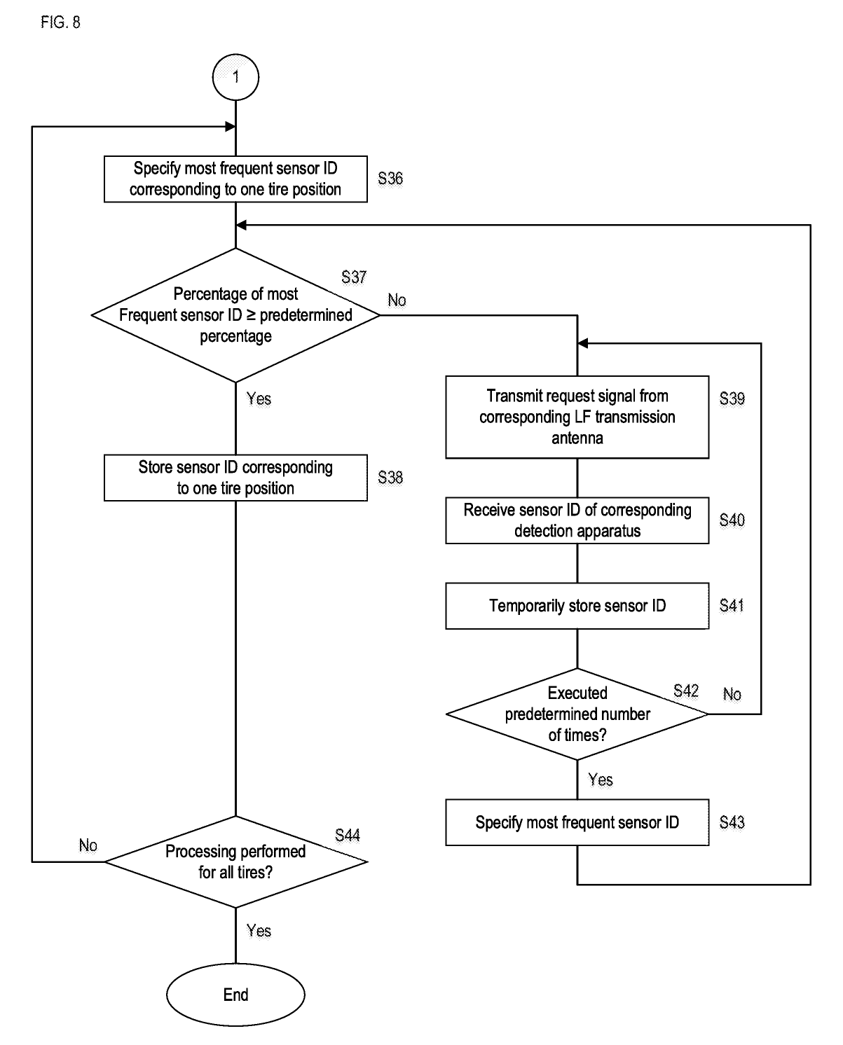

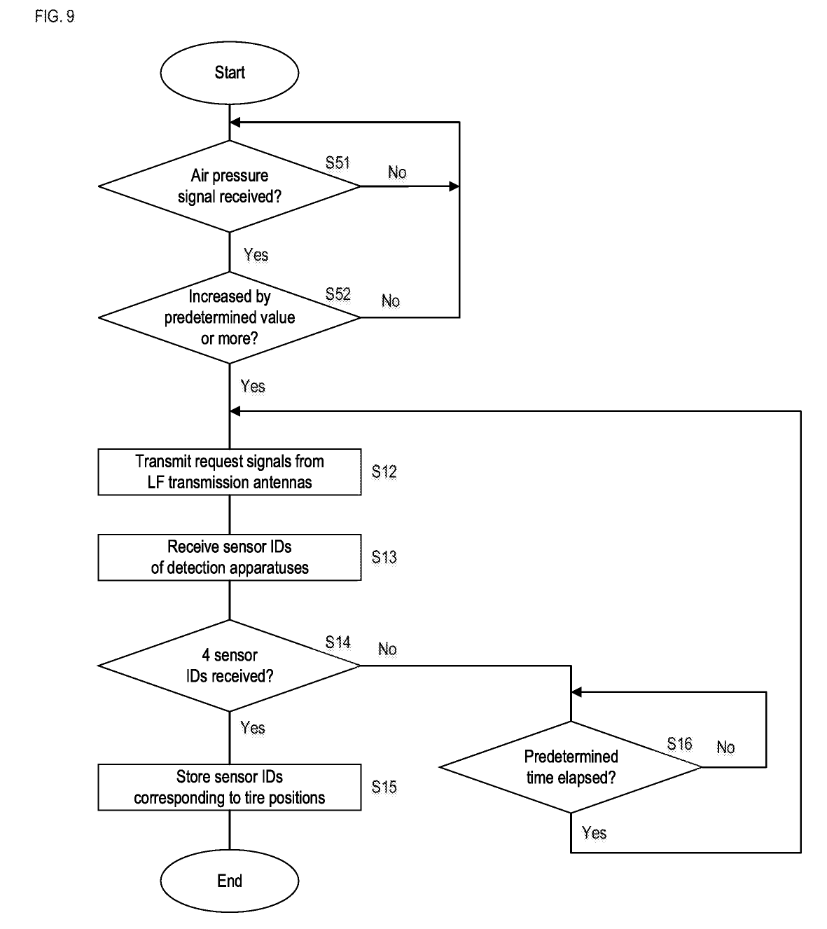

The following describes another variation of processing for updating sensor IDs registered in the sensor ID table. FIGS. 7 and 8 are flowcharts showing a sensor ID update processing procedure according to a second variation. In the processing procedure according to the second variation, the control unit 11 of the monitoring device 1 executes processing similar to step S11 in the processing procedure shown in FIG. 5.

Then, upon determining that a filling operation signal was received (S11: YES), the control unit 11 determines whether or not four sensor IDs transmitted by the detection devices 2 were received by the onboard reception unit 13 (S31). Note that the detection devices 2 each periodically detect the air pressure of the tire 3 and voluntarily transmit an air pressure signal to the monitoring device 1, and the control unit 11 receives the sensor IDs of the detection devices 2 by receiving the air pressure signals that are voluntarily transmitted by the detection devices 2.

Upon determining that four sensor IDs were not received (S31: NO), the control unit 11 waits until four sensor IDs have been received. Upon determining that four sensor IDs were received (S31: YES), the control unit 11 transmits a request signal for the sensor IDs of the detection devices 2 from the LF transmission antennas 14a (S32), receives the sensor IDs transmitted by the detection devices 2 in accordance with the transmitted request signals (S33), and temporarily stores the received sensor IDs in association with the tire positions (S34). Here, the control unit 11 may store the received sensor IDs in the RAM provided therein, or may store them in the storage unit 12.

The control unit 11 is configured such that the processing of steps S32 to S34 (transmission of request signal and reception and temporary storage of sensor ID) is executed a predetermined number of times for each of the LF transmission antennas 14a, and the control unit 11 determines whether this processing has been executed the predetermined number of times for each of the LF transmission antennas 14a (S35). Upon determining that the processing has not been executed the predetermined number of times (S35: NO), the control unit 11 returns to the processing of step S32. Upon determining that the processing has been executed the predetermined number of times for each of the LF transmission antennas 14a (S35: YES), the control unit (specification unit) 11 specifies a most frequent sensor ID that corresponds to one tire position (S36) based on the sensor IDs that were temporarily stored in step S34. For example, through the processing of steps S32 to S35, the control unit 11 transmits a request signal a predetermined number of times from the LF transmission antenna 14a that is at the front right of the vehicle C, and temporarily stores a predetermined number of sensor IDs, which were received in accordance with the request signals, in association with the front-right tire position. The control unit 11 then specifies the sensor ID that appears most often among the predetermined number of sensor IDs that were temporarily stored in association with the front-right tire position.

Upon specifying the most frequent sensor ID, the control unit 11 calculates the percentage of times that the specified sensor ID appears (the frequency of appearance), and determines whether or not the percentage for the most frequent sensor ID is greater than or equal to a predetermined percentage (S37). Upon determining that the percentage for the most frequent sensor ID is greater than or equal to the predetermined percentage (S37: YES), the control unit 11 stores the specified sensor ID as (uses the specified sensor ID to update) the sensor ID that corresponds to the aforementioned tire position in the sensor ID table (S38).

Upon determining that the percentage of the most frequent sensor ID is less than the predetermined percentage (S37: NO), the control unit 11 performs the processing of steps S32 to S36 once again for that tire position (the aforementioned one tire position).

Specifically, the control unit 11 transmits a sensor ID request signal from the LF transmission antenna 14a that corresponds to the tire position (S39), receives the sensor ID that is transmitted by the detection device 2 in accordance with the transmitted request signal (S40), and temporarily stores the received sensor ID (S41). The control unit 11 then determines whether or not the processing of steps S39 to S41 (transmission of request signal and reception and temporary storage of sensor ID) has been executed a predetermined number of times (S42), and upon determining that this processing has not been executed the predetermined number of times (S42: NO), returns to the processing of step S39. Upon determining that the processing has been executed the predetermined number of times (S42: YES), the control unit 11 specifies the most frequent sensor ID that corresponds to the tire position (S43) based on the sensor IDs that were temporarily stored in step S41. Thereafter, the control unit 11 moves to the processing of step S37.

After the processing of step S38, the control unit 11 determines whether or not updating has been performed for the sensor IDs that correspond to the all of the tire positions in the sensor ID table (S44). Upon determining that there is a tire position for which the sensor ID has not been updated (S44: NO), the control unit 11 returns to the processing of step S36, and performs the processing of steps S36 to S43 for a tire position for which processing is not complete. Upon determining that all of the sensor IDs have been updated (S44: YES), the control unit 11 ends this processing.

According to the above-described processing, for each tire position, the control unit 11 can specify, as the sensor ID that corresponds to the tire position, the sensor ID that is the most frequent sensor ID among the sensor IDs acquired the predetermined number of times from each detection device 2, and that has a frequency of appearance greater than or equal to the predetermined percentage. Accordingly, the sensor ID of a detection device of another vehicle will not be mistakenly registered in the sensor ID table, and the sensor IDs of the detection devices 2 of the own vehicle C can be reliably registered in the sensor ID table.

### Second Embodiment

The configuration of a tire air pressure monitoring system according to a second embodiment is similar to that in the first embodiment. Note that in the first embodiment, the sensor control units 21 of the detection devices 2 have a function of detecting that the filling of the tires 3 with air has started, the filling of the tires 3 with air is complete, or the like, but the detection devices 2 of the second embodiment do not have this function. Accordingly, in the second embodiment, the monitoring device 1 does not receive a filling operation signal from the detection devices 2.

In the tire air pressure monitoring system of the second embodiment, the timing at which the monitoring device 1 updates the sensor IDs registered in the sensor ID table is different from that in the first embodiment, and only this difference is described below.

FIG. 9 is a flowchart showing a sensor ID update processing procedure according to the second embodiment. The control unit 11 of the monitoring device 1 determines whether or not an air pressure signal transmitted by any of the detection devices 2 was received by the onboard reception unit 13 (S51). Note that the detection devices 2 each periodically detect the air pressure of the tire 3 and voluntarily transmit an air pressure signal to the monitoring device 1, and the control unit 11 successively receives the air pressure signals that are voluntarily transmitted by the detection devices 2.

Upon determining that an air pressure signal was received (S51: YES), the control unit 11 extracts a tire 3 air pressure and a sensor ID from the received air pressure signal. Upon receiving the air pressure signal, the control unit 11 updates the air pressure that corresponds to the sensor ID that was extracted from the air pressure signal in the sensor ID table to the air pressure that was extracted from the air pressure signal. At this time, the control unit 11 compares the air pressure stored before the update (the air pressure that had been stored in the sensor ID table) and the air pressure stored after the update (the air pressure that was extracted from the received air pressure signal), and determines whether or not the air pressure increased by a predetermined value or more (S52).

Upon determining that the air pressure increased by the predetermined value or more (S52: YES), the control unit 11 executes processing similar to steps S12 to S16 in the processing procedure shown in FIG. 5. Note that upon determining that an air pressure signal has not been received (S51: NO), or upon determining that the air pressure has not increased by the predetermined value or more (S52: NO), the control unit 11 returns to the processing of step S51, and repeats the processing of steps S51 and S52.

According to the above-described processing, in the second embodiment, if the air pressure of any of the tires 3 has increased by the predetermined value or more, the control unit 11 updates the correspondence relationship between the tire positions and the sensor IDs in the sensor ID table. Accordingly, the correspondence relationship between the tire positions and the sensor IDs in the sensor ID table is appropriately updated without attention from the driver, a mechanic, or the like.

If the air pressure of a tire 3 has increased by the predetermined value or more, there is a high possibility that the 3 has been filled with air, and in this case, there is a low possibility that another vehicle is present in the vicinity of the vehicle C. Accordingly, if the monitoring device 1 acquires the sensor IDs of the detection devices 2 of the own vehicle C in such a situation, it is possible to suppress the case where the sensor ID of a detection device of another vehicle is mistakenly acquired. The control unit 11 of the second embodiment has a function of a detection unit that, by determining whether or not the air pressure of any of the tires 3 has increased by the predetermined value or more, detects the existence or absence of a situation in which another vehicle is not present in the periphery of the own vehicle C.

The first and second variations described in the first embodiment can be applied to the tire air pressure monitoring system of the second embodiment as well. Specifically, in the case of applying the first variation to the second embodiment, the control unit 11 of the monitoring device 1 first performs the processing procedure shown in FIG. 9 (steps S51, S52, and S12 to S16), and then performs the processing procedure shown in FIG. 6 (steps S17 to S22). Also, in the case of applying the second variation to the second embodiment, the control unit 11 of the monitoring device 1 first performs the processing of steps S51 and S52 in the processing procedure shown in FIG. 9, and then performs the processing of steps S31 to S44 in the processing procedure shown in FIGS. 7 and 8. In these cases as well, the sensor IDs of the detection devices 2 of the own vehicle C can be reliably acquired and registered in the sensor ID table.

### Third Embodiment

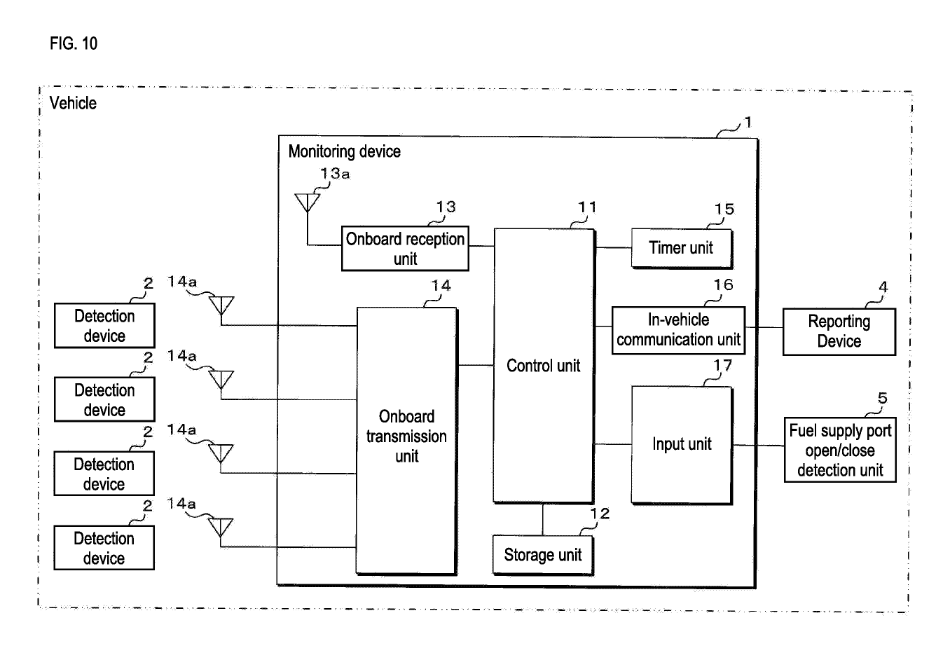

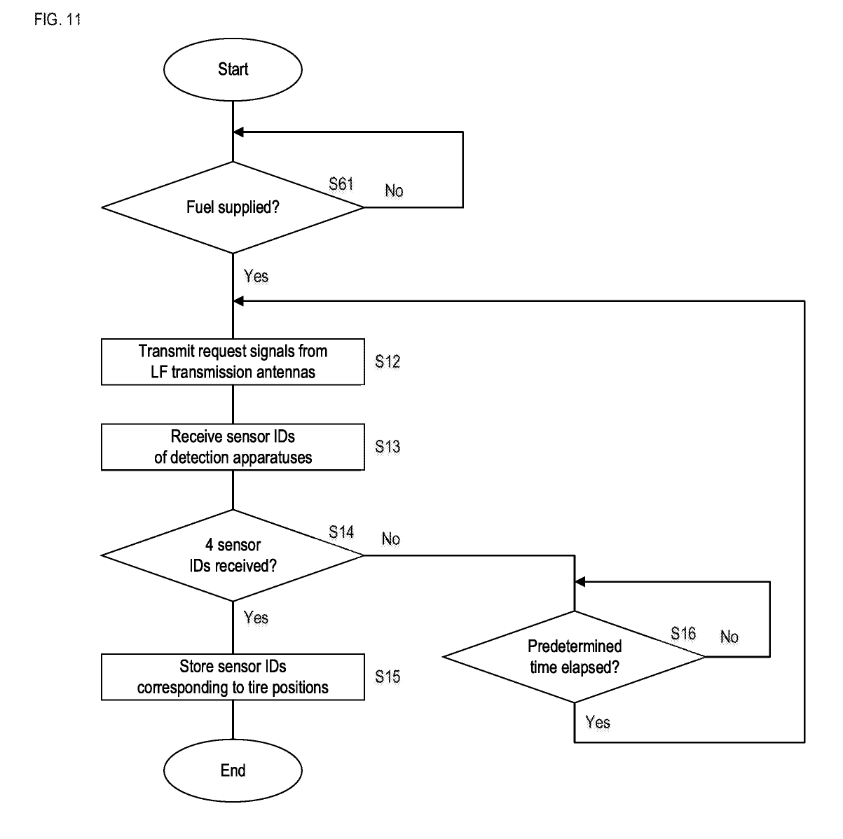

FIG. 10 is a block diagram showing an example of the configuration of the monitoring device 1 according to a third embodiment. The monitoring device 1 of the third embodiment has an input unit 17 in addition to the constituent units shown in FIG. 2, and the input unit 17 is connected to the control unit 11. A fuel supply port open/close detection unit 5 is connected to the input unit 17, and the fuel supply port open/close detection unit 5 outputs to the input unit 17 a signal indicating the open/closed state (open state or closed state) of a fuel supply port provided in the vehicle C. The fuel supply port open/close detection unit 5 is a switch for opening the fuel supply port, for example, and in this case, outputs to the input unit 17 a signal indicating the open state/closed state of the fuel supply port based on an operation performed on the switch. Also, the fuel supply port open/close detection unit 5 may be a sensor that detects the open/closed state of the fuel supply port, and in this case, outputs to the input unit 17 a signal indicating the sensor detection result (open state or closed state). The control unit 11 determines the open state/closed state of the fuel supply port based on the signal acquired from the fuel supply port open/close detection unit 5 via the input unit 17.

In the tire air pressure monitoring system of the third embodiment, the timing at which the monitoring device 1 updates the sensor IDs registered in the sensor ID table is different from that in the first and second embodiments, and only this difference is described below.

FIG. 11 is a flowchart showing a sensor ID update processing procedure according to the third embodiment. The control unit 11 of the monitoring device 1 determines whether or not fuel has been supplied to the own vehicle C based on a signal that is acquired from the fuel supply port open/close detection unit 5 via the input unit 17 (S61). For example, if it is detected that the fuel supply port was opened based on a signal acquired from the fuel supply port open/close detection unit 5, the control unit 11 determines that the supply of fuel to the vehicle C has started. Also, if it is detected that the fuel supply port was closed after being opened, the control unit 11 may determine that the supply of fuel to the vehicle C has ended.

Upon determining that fuel supply is not being performed (S61: NO), the control unit 11 waits until a determination that fuel supply has started is made. Upon determining that fuel supply was performed (S61: YES), the control unit 11 executes processing similar to steps S12 to S16 in the processing procedure shown in FIG. 5.

According to the above-described processing, in the third embodiment, if fuel is supplied to the vehicle C, the control unit 11 updates the correspondence relationship between the tire positions and the sensor IDs in the sensor ID table. Accordingly, the correspondence relationship between the tire positions and the sensor IDs in the sensor ID table is appropriately updated without attention from the driver, a mechanic, or the like.

If fuel is supplied to the vehicle C, there is a low possibility that another vehicle is present in the vicinity of the vehicle C. Accordingly, if the monitoring device 1 acquires the sensor IDs of the detection devices 2 of the own vehicle C in such a situation, it is possible to suppress the case where the sensor ID of a detection device of another vehicle is mistakenly acquired. The control unit 11 of the third embodiment has a function of a detection unit that, by determining whether or not fuel is supplied to the vehicle C, detects the existence or absence of a situation in which another vehicle is not present in the periphery of the own vehicle C. Note that besides a configuration in which whether or not fuel is supplied to the vehicle C is determined based on the open/closed state of the fuel supply port, which is detected by the fuel supply port open/close detection unit 5, a configuration is possible in which, for example, the remaining gasoline amount of the vehicle C is detected, and it is determined that fuel supply was performed if the remaining gasoline amount increased.

The first and second variations described in the first embodiment can be applied to the tire air pressure monitoring system of the third embodiment as well. Specifically, in the case of applying the first variation to the third embodiment, the control unit 11 of the monitoring device 1 first performs the processing procedure shown in FIG. 11 (steps S61, and S12 to S16), and then performs the processing procedure shown in FIG. 6 (steps S17 to S22). Also, in the case of applying the second variation to the third embodiment, the control unit 11 of the monitoring device 1 first performs the processing of step S61 in the processing procedure shown in FIG. 11, and then performs the processing of steps S31 to S44 in the processing procedure shown in FIGS. 7 and 8. In these cases as well, the sensor IDs of the detection devices 2 of the own vehicle C can be reliably acquired and registered in the sensor ID table.

The monitoring device 1 of the first embodiment detects the existence or absence of a situation in which another vehicle is not present in the periphery of the own vehicle C, that is to say the existence or absence of a situation in which the sensor IDs acquired from the detection devices 2 may be stored (registered) in the sensor ID table, in accordance with whether or not a filling operation signal was received from a detection device 2. Also, the monitoring device 1 of the second embodiment detects the existence or absence of a situation in which another vehicle is not present in the periphery of the own vehicle C in accordance with whether or not the air pressure of any of the tires 3 increased by a predetermined value or more. Moreover, the monitoring device 1 of the third embodiment detects the existence or absence of a situation in which another vehicle is not present in the periphery of the own vehicle C in accordance with whether or not fuel is supplied to the vehicle C. Additionally, a device that detects the present/absence of another vehicle in the periphery of the vehicle C may be provided in the vehicle C. For example, a camera that captures images of the periphery of the vehicle C may be provided in the vehicle C, and whether or not another vehicle is present in the periphery of the vehicle C may be determined by performing predetermined image processing on an image acquired by the camera.

In the first to third embodiments described above, the monitoring device 1 receives sensor IDs that were transmitted by the detection devices 2 in accordance with request signals transmitted by the own device 1, and stores the sensor IDs in the sensor ID table. Accordingly, the monitoring device 1 is configured such that sensor IDs received from the detection devices 2 can be stored in association with the tire positions. Alternatively, the monitoring device 1 may be configured such that the sensor IDs of the detection devices 2 of the own vehicle C are simply stored without being associated with tire positions. For example, a configuration is possible in which in the sensor ID update processing procedure in the first to third embodiments, instead of transmitting sensor ID request signals, the monitoring device 1 receives air pressure signals that are periodically transmitted by the detection devices 2, and updates the sensor ID table with the sensor IDs that are included in the received air pressure signals. In this case as well, the monitoring device 1 can reliably store (register) the sensor IDs of the detection devices 2 of the own vehicle C in the sensor ID table.

### FIG. 1

1 Monitoring device
4 Reporting device

### FIG. 2

[symbol] Vehicle
1 Monitoring device
2 Detection device
4 Reporting device
11 Control unit
12 Storage unit
13 Onboard reception unit
14 Onboard transmission unit
15 Timer unit
16 In-vehicle communication unit

### FIG. 3

[symbol] Tire position
[symbol] Antenna ID
[symbol] Sensor ID
[symbol] Air pressure
[symbol] Front-right
[symbol] Front-left
[symbol] Rear-right
[symbol] Rear-left

### FIG. 4

2 Detection device
21 Sensor control unit
22 Sensor storage unit
23 Sensor transmission unit
24 Sensor reception unit
25 Air pressure detection unit
26 Timer unit

### FIG. 5

[symbol] Start
[symbol] End
S11 Filling operation signal received?
S12 Transmit request signals from LF transmission antennas
S13 Receive sensor IDs of detection apparatuses
S14 4 sensor IDs received?
S15 Store sensor IDs corresponding to tire positions
S16 Predetermined time elapsed?

### FIG. 6

S15 Temporarily store sensor IDs corresponding to tire positions
S17 Started to travel?
S18 Transmit request signals from LF transmission antennas
S19 Receive sensor IDs of detection apparatuses
S20 4 sensor IDs received?
S21 Store sensor IDs corresponding to tire positions
S22 Predetermined time elapsed?

### FIG. 7

[symbol] Start
S11 Filling operation signal received?
S31 4 sensor IDs received?
S32 Transmit request signals from LF transmission antennas
S33 Receive sensor IDs of detection apparatuses
S34 Store sensor IDs corresponding to tire positions
S35 Executed predetermined number of times?

### FIG. 8

[symbol] End
S36 Specify most frequent sensor ID corresponding to one tire position
S37 Percentage of most frequent sensor ID≥predetermined percentage?
S38 Store sensor ID corresponding to one tire position
S39 Transmit request signal from corresponding LF transmission antenna
S40 Receive sensor ID of corresponding detection apparatus
S41 Temporarily store sensor ID
S42 Executed predetermined number of times?
S43 Specify most frequent sensor ID
S44 Processing performed for all tires?

### FIG. 9

[symbol] Start
[symbol] End
S51 Air pressure signal received?
S52 Increased by predetermined value or more?
S12 Transmit request signals from LF transmission antennas
S13 Receive sensor IDs of detection apparatuses
S14 4 sensor IDs received?
S15 Store sensor IDs corresponding to tire positions
S16 Predetermined time elapsed?

### FIG. 10

[symbol] Vehicle
Monitoring device
2 Detection device
4 Reporting device
5 Fuel supply port open/close detection unit
11 Control unit
12 Storage unit
13 Onboard reception unit
14 Onboard transmission unit
15 Timer unit
16 In-vehicle communication unit
17 Input unit

### FIG. 11

[symbol] Start
[symbol] End
S61 Fuel supplied?
S12 Transmit request signals from LF transmission antennas
S13 Receive sensor IDs of detection apparatuses
S14 4 sensor IDs received?
S15 Store sensor IDs corresponding to tire positions
S16 Predetermined time elapsed?

1. An onboard storage device that receives and stores identification information pieces that are transmitted by a plurality of communication devices that are respectively provided in a plurality of tires of a vehicle and wirelessly transmit respective identification information pieces, the onboard storage device comprising:
a reception unit that receives the identification information pieces respectively transmitted by the communication devices;
a detection unit that detects whether or not an air filling operation performed with respect to at least one tire started or ended; and
a storage unit that, if the detection unit detected that the air filling operation performed with respect to at least one tire started or ended existence of a situation in which another vehicle is not present, stores the identification information pieces received by the reception unit.

2. The onboard storage device according to claim 1,
further comprising a transmission unit that, if the detection unit detected that the air filling operation performed with respect to at least one tire started or ended, wirelessly transmits a request signal to each of the communication devices, the request signals requesting the identification information pieces,
wherein the reception unit receives the identification information pieces that were transmitted by the communication devices in accordance with the request signals that were wirelessly transmitted by the transmission unit.

3. (canceled)

4. The onboard storage device according to claim 1, wherein the detection unit further detects whether or not an air pressure of at least one tire increased by a predetermined value or more, and
if the detection unit detected that the air pressure increased by the predetermined value or more, the storage unit stores the received identification information pieces.

5. The onboard storage device according to claim 1, wherein the detection unit further detects whether or not supply of fuel to the vehicle started or ended, and
if the detection unit detected that the supply of fuel to the vehicle started or ended, the storage unit stores the received identification information pieces.

6. The onboard storage device according to claim 1, wherein if the reception unit received a larger number of identification information pieces than a total number of tires provided in the vehicle, the storage unit does not store the identification information pieces received by the reception unit.

7. The onboard storage device according to claim 1,
further comprising a temporary storage unit that, after the detection unit detected that the air filling operation performed with respect to at least one tire started or ended, if the reception unit received a total number of identification information pieces that is identical to a total number of tires provided in the vehicle, temporarily stores the identification information pieces received by the reception unit; and
a determination unit that determines whether or not the vehicle started to travel,
wherein the storage unit stores the identification information pieces received by the reception unit after the determination unit determines that the vehicle started to travel.

8. The onboard storage device according to claim 1,
wherein the reception unit receives the identification information pieces that were transmitted a plurality of times by each of the communication devices,
the onboard storage device further comprises a specification unit that specifies a corresponding identification information piece for each of the communication devices based on the plurality of identification information pieces received from each of the communication devices by the reception unit, and
the storage unit stores the identification information pieces that were specified by the specification unit and correspond to the communication devices.

9. An onboard storage system comprising:
the onboard storage device according to claim 1, and
a plurality of communication devices that are respectively provided in a plurality of tires of a vehicle and wirelessly transmit respective identification information pieces.
